(19) United States
(12) Patent Application Publication
(10) Pub. No.: US 2026/0160310 A1
(43) Pub. Date: Jun. 11, 2026

(54) BUFFER DEVICE

(71) Applicant: Honda Motor Co., Ltd., Tokyo (JP)

(72) Inventor: Nobuhiro YAMADA, Saitama (JP)

(73) Assignee: Honda Motor Co., Ltd., Tokyo (JP)

(21) Appl. No.: 19/403,039

(22) Filed: Nov. 27, 2025

(30) Foreign Application Priority Data
Dec. 10, 2024 (CN) 202411804516.1

(51) Int. Cl. F16F 9/34; F16F 9/18

(52) U.S. Cl. CPC F16F 9/3405; F16F 9/185

(57) ABSTRACT

A buffer device includes: an internal cylinder having an internal space; an intermediate cylinder set on an outer side of the internal cylinder; a cover body covering openings located at the internal cylinder and the intermediate cylinder; a flow path formed by a space between the internal cylinder and the intermediate cylinder; a piston movably installed in the internal cylinder and dividing the internal space into first and second chambers; and a piston rod having a first end connected with the piston and a second end extending toward an outer side. A valve body is set between the cover body and the internal cylinder, the valve body has a main flow path communicating with the first chamber and the flow path, and a length of the main flow path in a radial direction is shorter than a distance between the internal cylinder and the piston rod in the radial direction.

### CROSS-REFERENCE TO RELATED APPLICATION

This application claims the priority benefit of China application serial no. 202411804516.1, filed on December 10, 2024. The entirety of the above- mentioned patent applications is hereby incorporated by reference herein and made part of this specification.

### BACKGROUND

### TECHNICAL FIELD

The present invention relates to a buffer device, and more particularly to a buffer device that may be applied in a vehicle and connected with a damping force generation device to generate damping force.

### Related Art

In recent years, efforts have been active to provide access to sustainable transportation systems that also consider vulnerable people among traffic participants, such as elderly people, disabled people, or children. To achieve the said purpose, research and development are being conducted to further improve traffic safety or convenience through development related to vehicle behavioral stability. However, in technology related to vehicle behavioral stability, the buffer effect of the buffer device installed in the vehicle is an issue.

In the prior art, the buffer device includes an internal cylinder that accommodates liquid (for example, oil), an intermediate cylinder set on the outside of the internal cylinder, a cover body that covers the openings of the internal cylinder and the intermediate cylinder, and a flow path formed by the space between the internal cylinder and the intermediate cylinder, and further provides a piston movably installed in the internal cylinder, and a piston rod connected with the piston and extending toward the outside through the cover body. The buffer device further connects a damping force generation device that communicates with the flow path. As such, through the elongation and contraction of the piston rod, the piston moves reciprocally in the internal cylinder, and the liquid may flow in the internal cylinder and the flow path. After the liquid is driven by the piston and flows from the internal cylinder into the flow path, the liquid flows into the damping force generation device that communicates with the flow path, and generates damping force through the flow resistance of the electric control valve (for example, a solenoid valve) set in the damping force generation device. However, in the above buffer device, how to improve the damping force when the piston extends and contracts at high speed and improve the ride comfort of the vehicle is an issue. In the high-speed region of piston velocity, response delay may occur due to sensor delay or delay in the operation of the electronic control valve, and even if attempting to generate large damping force in this velocity region, it may not be possible to generate it at the appropriate time. On the other hand, even if using piston valves or bottom valves of other hydraulic generation parts to generate damping force, there is difficulty because the flow rate of oil flowing into them is limited.

The present invention aims to solve the aforementioned problems by providing a buffer device that can generate damping force without response delay and produce more damping force in the high-speed region of piston velocity to improve damping performance, and can improve vehicle ride comfort and handling stability through the improvement of damping force.

### [Prior Art Literature]

### [Patent Document]

[Patent Document 1] Japanese Patent Publication No. 2024-14556

### SUMMARY

The present invention provides a buffer device that enables no response delay and generates more damping force in a high-speed region of piston velocity to improve damping performance, and enables improvement of ride comfort and handling stability of a vehicle through the improvement of damping force.

The present invention provides a buffer device. The buffer device includes: an internal cylinder having an internal space with liquid sealed in the internal space; an intermediate cylinder set on an outer side of the internal cylinder; a cover body covering openings located at one end of the internal cylinder and the intermediate cylinder; a flow path formed by a space between the internal cylinder and the intermediate cylinder; a piston movably mounted in the internal cylinder and dividing the internal space of the internal cylinder into a first chamber and a second chamber; and a piston rod having a first end connected with the piston and a second end extending toward an outer side through the first chamber and the cover body, wherein a valve body connected with the cover body is provided between the cover body and the internal cylinder, the valve body has a main flow path communicating with the first chamber and the flow path and allowing the liquid to flow through, and a length of the main flow path in a radial direction is shorter than a distance between the internal cylinder and the piston rod in the radial direction.

In the buffer device of the embodiment of the present invention, the piston rod has a stopper that sets a stretching distance of the piston rod, the main flow path has a main entrance that opens toward the first chamber and a main outlet that opens toward the flow path, the valve body further has a bypass flow path that communicates with the first chamber and the flow path and allows the liquid to flow, the bypass flow path has a bypass inlet that opens toward the first chamber and a bypass outlet that opens toward the flow path, and the bypass inlet opens toward a side surface of the internal cylinder.

In the buffer device of the embodiment of the present invention, the main outlet serves as the bypass outlet, and the bypass inlet is connected with the main outlet that serves as the bypass outlet.

In the buffer device of the embodiment of the present invention, the valve body has a cover sealing part that is closer to the cover body than the main outlet and is located between the cover body and the intermediate cylinder, and a part of the side surface of the cover body presses the intermediate cylinder and the cover sealing part.

In the buffer device of the embodiment of the present invention, the cross-sectional area of the main outlet is smaller than the cross-sectional area of the bypass inlet.

In the buffer device of the embodiment of the present invention, a seal is provided on an outer periphery of the valve body, and the seal is located between the bypass inlet and the main outlet.

In the buffer device of the embodiment of the present invention, a rod guide is provided between the cover body and the piston rod, a cover body clearance is between the cover body and the rod guide, and the cover body clearance is connected with the main flow path.

Based on the above, in the buffer device of the present invention, through elongation and contraction of the piston rod in the length direction to drive the piston to move reciprocally in the internal cylinder, the liquid may flow in the internal cylinder and the flow path. The valve body connected with the cover body is set between the cover body and the internal cylinder, the first chamber of the internal cylinder and the flow path are connected with each other through the main flow path of the valve body to allow liquid flow, and the length of the main flow path in the radial direction is shorter than the distance between the internal cylinder and the piston rod in the radial direction. In the condition that the piston rod contracts to move the piston toward the second chamber of the internal cylinder, the liquid flows from the second chamber toward the first chamber through the movement of the piston, and then flows toward the flow path more efficiently through the main flow path of the valve body with short length. Thus, the liquid may generate additional damping force reliably at the corresponding part when the piston moves at high velocity, and may generate damping force stably when the buffer device is further connected with the damping force generation device. Accordingly, the buffer device of the present invention may generate more damping force in the high velocity region of piston velocity with no response delay to improve damping performance, and may improve ride comfort and handling stability of the vehicle through the improvement of damping force.

To make the above features and advantages of the present invention more obvious and understandable, the following specific examples are given and described in detail with the accompanying drawings.

### BRIEF DESCRIPTION OF THE DRAWINGS

FIG. 1 is a partial cross-sectional schematic view of a buffer device according to an embodiment of the present invention after cutting open a part thereof along the length direction.

FIG. 2 is a partial enlarged cross-sectional schematic diagram of the buffer device shown in FIG. 1 in the vicinity of the valve body when the piston rod is in a contracted state.

FIG. 3 is a partial enlarged cross-sectional schematic diagram of the buffer device shown in FIG. 1 in the vicinity of the valve body when the piston rod is in an elongated state.

FIG. 4 is a perspective schematic diagram of the valve body used in the buffer device shown in FIG. 1.

### DESCRIPTION OF THE EMBODIMENTS

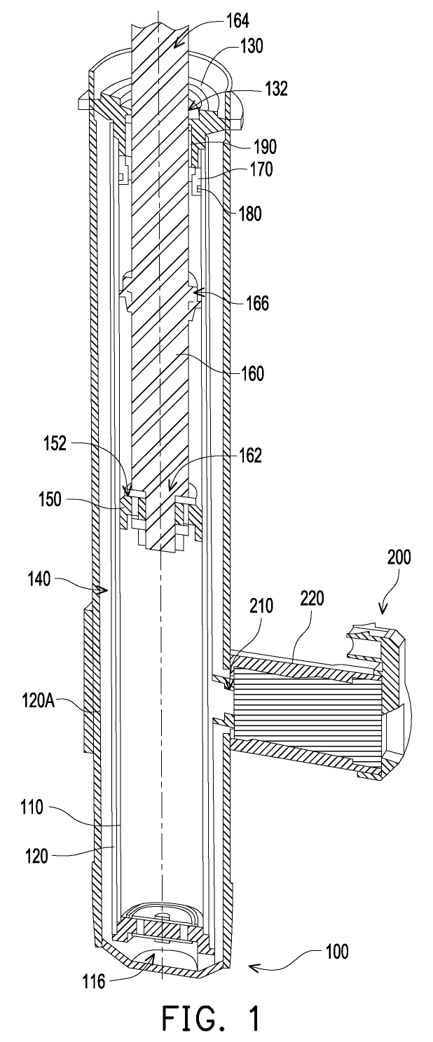

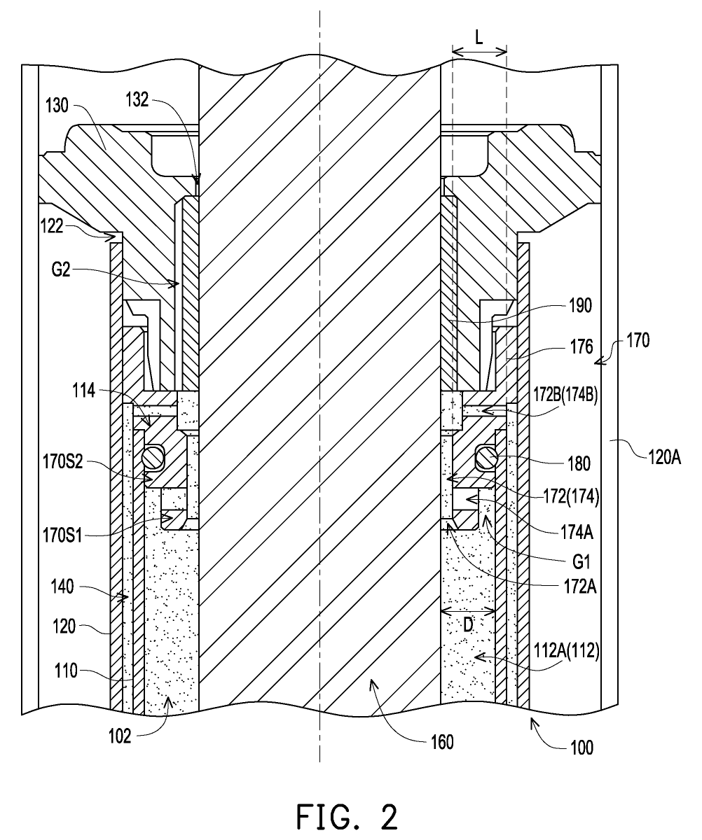

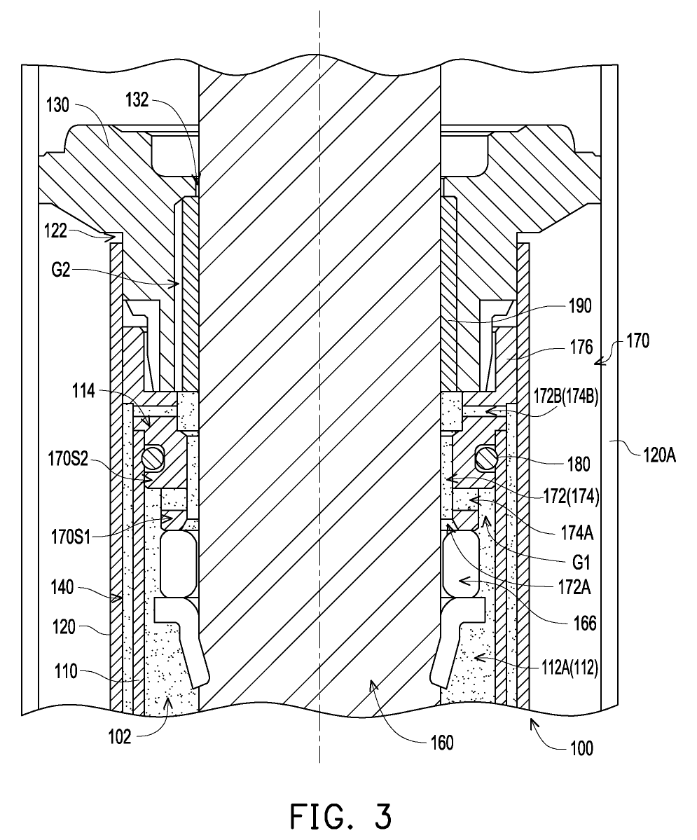

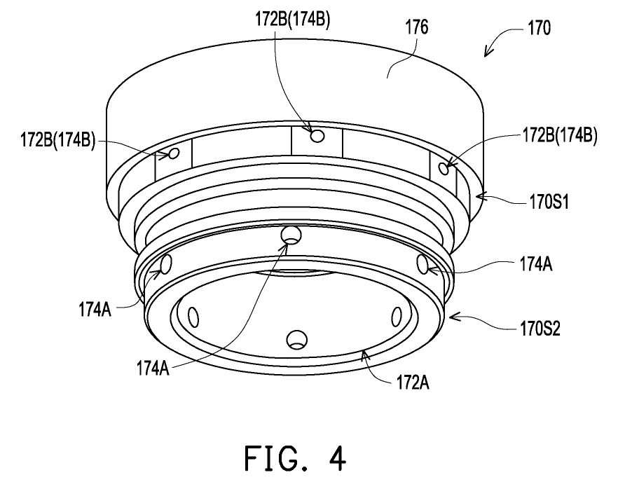

Exemplary embodiments of the present invention will now be described in detail with reference to examples of the exemplary embodiments illustrated in the accompanying drawings. FIG. 1 is a partial cross-sectional schematic view of a buffer device according to an embodiment of the present invention with a portion cut along a length direction, FIG. 2 is a locally enlarged cross-sectional schematic view near a valve body when the piston rod is in a contract state of the buffer device shown in FIG. 1, FIG. 3 is a locally enlarged cross-sectional schematic view near the valve body when the piston rod is in an elongate state of the buffer device shown in FIG. 1, and FIG. 4 is a three-dimensional schematic view of the valve body used in the buffer device shown in FIG. 1. The specific structure of the buffer device 100 of this embodiment and the application means of the buffer device 100 connected with the damping force generation device 200 to generate damping force when applied in a vehicle (not shown) will be described below with reference to FIG. 1 to FIG. 4, but this is only one example, and the present invention is not limited thereto, and may be adjusted according to needs.

Please refer to FIG. 1 to FIG. 3, in this embodiment, the buffer device 100 includes an internal cylinder 110, an intermediate cylinder 120, a cover body 130, a flow path 140, a piston 150, a piston rod 160, and a valve body 170. The internal cylinder 110 has an internal space 112, and liquid 102 (for example, oil) is sealed in the internal space 112. The intermediate cylinder 120 is set on the outer side of the internal cylinder 110. The cover body 130 covers the opening 114 and opening 122 located at one side end (for example, the upper side end in the drawing) of the internal cylinder 110 and the intermediate cylinder 120. The flow path 140 is formed by the space between the internal cylinder 110 and the intermediate cylinder 120. The piston 150 is movably installed in the internal cylinder 110, and divides the internal space 112 of the internal cylinder 110 into a first chamber 112A and a second chamber 112B. The piston rod 160 has a first end 162 connected with the piston 150, and a second end 164 extending toward the outer side (for example, the upper side in the drawing) through the first chamber 112A and the cover body 130. The valve body 170 connected with the cover body 130 is set between the cover body 130 and the internal cylinder 110. The valve body 170 has a main flow path 172 that communicates with the first chamber 112A and the flow path 140 and allows the liquid 102 to flow. Moreover, the length L in the radial direction of the main flow path 172 (indicated in FIG. 2) is shorter than the distance D in the radial direction between the internal cylinder 110 and the piston rod 160 (indicated in FIG. 2).

Specifically, in the present embodiment, as shown in FIG. 1 to FIG. 3, the internal cylinder 110 is, for example, an elongated cylindrical structure extending in a length direction (for example, up-down direction in the drawings) and has an internal space 112. The intermediate cylinder 120 is, for example, an elongated cylindrical structure extending in the length direction and surrounds the internal cylinder 110. Furthermore, a tube body 120A of the elongated cylindrical structure may be further provided on an outer side of the intermediate cylinder 120. One side end (for example, an upper side end in the drawings) of the internal cylinder 110 and the intermediate cylinder 120 has an opening 114 and an opening 122. A cover body 130 covers the opening 114 of the internal cylinder 110 and the opening 122 of the intermediate cylinder 120. The internal cylinder 110 and the intermediate cylinder 120 are spaced apart from each other to form a flow path 140, and a relative position of the internal cylinder 110 and the intermediate cylinder 120 (for example, coaxially set) may be limited through the cover body 130. Correspondingly, another side end of the intermediate cylinder 120 (for example, a lower side end in the drawings) has a bottom and is closed, and another side end of the internal cylinder 110 has a bottom and is provided with a bottom valve 116. Thus, the internal space 112 of the internal cylinder 110 and the flow path 140 are connected through the flow path in the bottom valve 116, and the intermediate cylinder 120 serves as a shell of the buffer device 100 to seal the liquid 102. Furthermore, the cover body 130 is provided with a rod hole 132 for the piston rod 160 to pass through. However, the present invention does not limit the specific structures of the internal cylinder 110, the intermediate cylinder 120, the cover body 130, and the flow path 140, which may be adjusted according to the needs.

Furthermore, in the present embodiment, as shown in FIG. 1, the piston 150 is, for example, a circular plate body that extends in the width direction and contacts the inner wall of the internal cylinder 110 (illustrated as a semicircular plate body after being cut in FIG. 1), so that the piston 150 may be driven by the piston rod 160 to reciprocate (slide) along the inner wall of the internal cylinder 110 in the length direction (for example, the up-down direction in the drawing), and divides the internal space 112 of the internal cylinder 110 into a first chamber 112A (for example, the part on the upper side in the drawing) close to the cover body 130 and a second chamber 112B (for example, the part on the lower side in the drawing) away from the cover body 130. As an example, the piston 150 is provided with a one-way valve 152 that opens toward the first chamber 112A side and is closed on the second chamber 112B side. Thus, the first chamber 112A and the second chamber 112B are unidirectionally connected toward the first chamber 112A through the one-way valve 152 of the piston 150. Correspondingly, the piston rod 160 is, for example, a circular rod body extending in the length direction (for example, the up-down direction in the drawing), with its first end 162 (for example, the end on the lower side in the drawing) connected to the piston 150, and its second end 164 (for example, the end on the upper side in the drawing) extending outward through the first chamber 112A and the cover body 130. Thus, the piston rod 160 may elongate and contract in the length direction (for example, the up-down direction in the drawing) through driving by a drive source not shown, and drive the piston 150 to reciprocate in the internal cylinder 110 (for example, move toward the upper side and lower side in the drawing). The liquid 102 sealed in the internal space 112 of the internal cylinder 110 and stored in the flow path 140 may flow between the internal space 112 and the flow path 140 through the driving of the piston rod 160 and the piston 150. However, the present invention does not limit the specific structures of the piston 150 and the piston rod 160, which may be adjusted according to the needs.

Additionally, in the present embodiment, as shown in FIG. 1 to FIG. 4, the valve body 170 is, for example, an annular member set at the end of the cover body 130 toward the internal cylinder 110 (for example, the end on the lower side in the drawings) and connected with the cover body 130 (illustrated as a half-annular shape after cutting in FIG. 1), and is set near the opening 114 of the internal cylinder 110, thereby being positioned between the cover body 130 and the internal cylinder 110. Moreover, the piston rod 160 extending outward through the rod hole 132 of the cover body 130 also passes through the opening of the annular valve body 170. The main flow path 172 is set inside the valve body 170 and opens at the surface, thereby being connected with the first chamber 112A and the flow path 140. Furthermore, the length L of the main flow path 172 in the radial direction (indicated in FIG. 2) is shorter than the distance D between the internal cylinder 110 and the piston rod 160 in the radial direction (indicated in FIG. 2). Thus, compared with the condition where the valve body 170 is not provided and the liquid 102 flows from the region between the internal cylinder 110 and the piston rod 160 to the flow path 140 through an additional cylinder opening (not shown), in the condition where the valve body 170 is provided, the liquid 102 may flow more effectively from the region between the internal cylinder 110 and the piston rod 160 to the flow path 140 through the main flow path 172 of the valve body 170 with the short length L. However, the present invention does not limit the specific structure of the valve body 170, which may be adjusted according to the needs.

From this, it can be known that in the present embodiment, the internal space 112 of the internal cylinder 110 (including the first chamber 112A and the second chamber 112B) and the flow path 140 are connected to each other through the main flow path 172 of the valve body 170, the flow path in the bottom valve 116 of the internal cylinder 110, and the one-way valve 152 of the piston 150, and the liquid 102 may flow between the internal space 112 and the flow path 140 through the drive of the piston rod 160 and the piston 150. As an example, in the condition where the piston rod 160 contracts and drives the piston 150 to move toward a side away from the cover body 130 and toward the direction approaching the second chamber 112B (for example, moving toward the lower side in the drawing), at least a part of the liquid 102 in the second chamber 112B flows toward the first chamber 112A through the one-way valve 152 that opens toward the first chamber 112A side, and at least a part of the liquid 102 in the first chamber 112A flows toward the flow path 140 through the main flow path 172 of the valve body 170. Corresponding to this, in the condition where the piston rod 160 elongates and drives the piston 150 to move toward a side approaching the cover body 130 and toward the direction approaching the first chamber 112A (for example, moving toward the upper side in the drawing), at least a part of the liquid 102 in the first chamber 112A is blocked by the one-way valve 152 and flows toward the flow path 140 through the main flow path 172 of the valve body 170, and at least a part of the liquid 102 in the flow path 140 flows toward the second chamber 112B through the flow path in the bottom valve 116. In this process, the length L in the radial direction of the main flow path 172 (indicated in FIG. 2) is short, so that the liquid 102 may flow more efficiently toward the flow path 140 through the main flow path 172 of the valve body 170. Thus, the liquid may generate additional damping force at corresponding parts when the piston moves at high velocity. Therefore, the buffer device 100 may have no response delay and generate more damping force in the high velocity region of the velocity of the piston 150 to improve damping performance, and may improve the ride comfort and handling stability of the vehicle through the improvement of damping force. However, the present invention does not limit the operation method of the buffer device 100, which may be adjusted according to the needs.

Furthermore, in the present embodiment, as shown in FIG. 1, the buffer device 100 may be applied in a vehicle (not shown) and connected with the damping force generation device 200 to generate damping force. As an example, the damping force generation device 200 exemplifies a device provided with an electric control valve 210 (exemplifying an electromagnetic valve) and generates damping force through flow resistance generated by the electric control valve 210 in response to liquid flowing into the damping force generation device 200. Wherein, one end of the damping force generation device 200 is connected with the flow path 140. Thus, after the liquid 102 is driven by the piston rod 160 and the piston 150 to flow from the internal cylinder 110 into the flow path 140, the liquid 102 flows into the damping force generation device 200 connected with the flow path 140, and generates damping force through the flow resistance of the electric control valve 210 provided in the damping force generation device 200. Here, the damping force generation device 200 only shows the electric control valve 210 and the shell 220 accommodating the electric control valve 210, and other structures are omitted for explanation. Moreover, the specific structure of the damping force generation device 200 may be adjusted according to the needs, and the buffer device 100 may also be applied to other devices that need to supply liquid, and the present invention is not limited thereto.

Through the above configuration, in the buffer device 100 of the present embodiment, the piston 150 may be driven to reciprocate in the internal cylinder 110 (for example, move toward the upper side and lower side in the drawings) through elongation and contraction of the piston rod 160 in the length direction (for example, the up-down direction in the drawings), enabling the liquid 102 to flow in the internal cylinder 110 and the flow path 140. The valve body 170 connected with the cover body 130 is provided between the cover body 130 and the internal cylinder 110, the first chamber 112A of the internal cylinder 110 and the flow path 140 are connected with each other through the main flow path 172 of the valve body 170 to allow the liquid 102 to flow, and the length L of the main flow path 172 in the radial direction is shorter than the distance D between the internal cylinder 110 and the piston rod 160 in the radial direction. In the condition where the piston rod 160 contracts and the piston 150 moves toward the second chamber 112B of the internal cylinder 110 (for example, moves toward the lower side in the drawings), the liquid 102 flows from the second chamber 112B toward the first chamber 112A through movement of the piston 150, and then flows more efficiently toward the flow path 140 through the main flow path 172 of the valve body 170 with the short length L. Thus, the liquid 102 may reliably generate additional damping force at corresponding parts when the piston 150 moves at high velocity, and may stably generate damping force when the buffer device 100 is further connected with the damping force generation device 200. Accordingly, the buffer device 100 may generate more damping force in the high velocity region of the velocity of the piston 150 with no response delay to improve damping performance, and may improve ride comfort and handling stability of the vehicle through improvement of the damping force.

Furthermore, in the present embodiment, as shown in FIG. 1 to FIG. 3, the piston rod 160 has a stopper 166 that sets the stretching distance of the piston rod 160. The stopper 166 is, for example, an annular protruding structure provided on the rod body of the piston rod 160 (illustrated as a cut semicircular ring in FIG. 1), and its radial dimension is larger than the radial dimensions of the rod body of the piston rod 160 and the rod hole 132 on the cover body 130 through which the piston rod 160 passes. In the condition where the piston rod 160 elongates and drives the piston 150 to move toward the first chamber 112A, the piston rod 160 may only elongate until the stopper 166 abuts against the end of the valve body 170 (as shown in FIG. 3) and cannot elongate further. That is, the elongation distance of the piston rod 160 is set to the distance that the stopper 166 moves to contact the end of the valve body 170. Thus, the stretching distance of the piston rod 160 may be effectively set, and the elongation and contraction of the piston rod 160 are more stable. However, in other embodiments not shown, the provision of the stopper 166 may also be omitted, and the elongation distance of the piston rod 160 is set to the distance that the piston 150 moves to contact the end of the valve body 170. Correspondingly, in the condition where the piston rod 160 contracts and drives the piston 150 to move toward the second chamber 112B, the contraction distance of the piston rod 160 is set to the distance that the piston 150 moves to contact the bottom of the internal cylinder 110. In other embodiments not shown, a stopper may also be provided at the second end 164 of the piston rod 160. Furthermore, the stretching distance of the piston rod 160 may also be set through the drive stroke of a drive source (not shown) for driving the piston rod 160. The present invention does not limit the specific structure, installation position, and whether or not to provide the stopper 166, and does not limit the means for setting the stretching distance of the piston rod 160, which may be adjusted according to the needs.

Furthermore, in the present embodiment, as shown in FIG. 2 and FIG. 3, the main flow path 172 has a main entrance 172A that opens toward the first chamber 112A, and a main outlet 172B that opens toward the flow path 140. The main entrance 172A is set at an end of the valve body 170 facing the first chamber 112A (for example, the end on the lower side in the drawing), and the main outlet 172B is set at a side part of the valve body 170 facing the flow path 140 (i.e., the space between the internal cylinder 110 and the intermediate cylinder 120), while the main flow path 172 passes through the interior of the valve body 170. In addition, the valve body 170 also has a bypass flow path 174 that is connected with the first chamber 112A and the flow path 140 and allows the liquid 102 to flow. The bypass flow path 174 has a bypass inlet 174A that opens toward the first chamber 112A, and a bypass outlet 174B that opens toward the flow path 140. The bypass inlet 174A opens toward the side surface of the internal cylinder 110, i.e., is set at a side part of the valve body 170 facing the side surface of the internal cylinder 110, while the bypass flow path 174 passes through the interior of the valve body 170. As an example, there is a cylinder clearance G1 between the bypass inlet 174A and the internal cylinder 110. That is, the side part of the valve body 170 provided with the bypass inlet 174A does not contact the inner side surface of the internal cylinder 110.

Through the above configuration, in the present embodiment, through the driving of the piston rod 160 and the piston 150, the liquid 102 may flow from the first chamber 112A to the flow path 140 through the main flow path 172 and the bypass flow path 174 of the valve body 170. In particular, as shown in FIG. 3, in the condition where the piston rod 160 elongates and drives the piston 150 to move toward the direction approaching the first chamber 112A, since the piston rod 160 may elongate until the stopper 166 abuts against the end of the valve body 170, and the main entrance 172A is set at the end of the valve body 170 facing the first chamber 112A, there is a concern that the stopper 166 blocks the main entrance 172A. At this time, since the valve body 170 is further provided with the bypass flow path 174 and the bypass inlet 174A opens toward the side surface of the internal cylinder 110, the stopper 166 does not block the bypass inlet 174A. Thus, in the condition where the piston rod 160 elongates and drives the piston 150 to move toward the direction approaching the first chamber 112A, even if the stopper 166 blocks the main entrance 172A, the liquid 102 may also flow from the first chamber 112A to the flow path 140 through the guidance of the bypass flow path 174. In particular, the liquid 102 may smoothly flow into the bypass inlet 174A through the cylinder clearance G1. Thus, the buffer device 100 may have no response delay and generate more damping force in the high velocity region of the velocity of the piston 150 to improve damping performance, and may improve the ride comfort and handling stability of the vehicle through the improvement of the damping force.

Furthermore, in the present embodiment, as shown in FIG. 2 and FIG. 3, the main outlet 172B serves as the bypass outlet 174B, and the bypass inlet 174A is connected with the main outlet 172B that serves as the bypass outlet 174B. That is, the same outlet is used as the main outlet 172B and the bypass outlet 174B, and the main flow path 172 and the bypass flow path 174 share part of the flow path. According to the above description, as long as the main entrance 172A and the bypass inlet 174A are separated to avoid the liquid 102 being difficult to inflow into the valve body 170, there is no limit on whether the main outlet 172B and the bypass outlet 174B are separated or shared. Through the same outlet as the main outlet 172B and the bypass outlet 174B, regardless of whether the liquid 102 flows through the main flow path 172 or the bypass flow path 174 to the flow path 140, its flow characteristics such as flow rate will not change, so that when the buffer device 100 is applied in a vehicle (not shown) and connected with the damping force generation device 200 (shown in FIG. 1) to generate damping force, passengers of the vehicle will not feel any sense of discomfort. However, in other embodiments not shown, the main outlet 172B and the bypass outlet 174B may also be separated, as long as the liquid 102 can flow from the first chamber 112A to the flow path 140 through the main flow path 172 and the bypass flow path 174. Moreover, the setting of the bypass flow path 174 may also be omitted, and by adjusting the position of the main entrance 172A to avoid being blocked by the stopper 166, or as mentioned above, the setting of the stopper 166 may be omitted without concern of the main entrance 172A being blocked. The present invention is not limited to this and may be adjusted according to the needs.

Furthermore, in the present embodiment, as shown in FIG. 2 to FIG. 4, one part of the main flow path 172 is exemplified as being formed by the space between the inner side surface of the valve body 170 and the outer peripheral surface of the piston rod 160, and another part of the main flow path 172 is exemplified as being formed at one end side of the side part of the valve body 170 (for example, the upper side in the drawing) and communicating the inside and outside of the valve body 170. The main entrance 172A is exemplified as being formed as an annular opening between the inner side surface of the valve body 170 and the outer peripheral surface of the piston rod 160, and the main outlet 172B is exemplified as being formed as a plurality of through holes formed at the outer end surface of one end side part of the valve body 170 and arranged dispersedly along the circumference. Correspondingly, one part of the bypass flow path 174 is exemplified as being formed at the other end side of the side part of the valve body 170 (for example, the lower side in the drawing) and communicating the inside and outside of the valve body 170, and another part of the bypass flow path 174 is exemplified as being shared with the main flow path 172. The bypass inlet 174A is exemplified as being formed as a plurality of through holes formed at the outer end surface of the other end side part of the valve body 170 and arranged dispersedly along the circumference, and the bypass outlet 174B serves as the main outlet 172B. Thus, the main entrance 172A configured as an annular opening and the bypass inlet 174A configured as a plurality of through holes arranged dispersedly along the circumference enable the liquid 102 to flow uniformly into the valve body 170, and the main outlet 172B (serves as the bypass outlet 174B) configured as a plurality of through holes arranged dispersedly along the circumference enable the liquid 102 to flow uniformly out of the valve body 170.

As an example, as shown in FIG. 2 to FIG. 4, in this embodiment, the cross-sectional area of the main outlet 172B that serves as the bypass outlet 174B is smaller than the cross-sectional area of the bypass inlet 174A. In the condition where the main outlet 172B is configured as multiple through holes dispersed and arranged along the circumference, the cross-sectional area of the main outlet 172B refers to the total combined cross-sectional area of all the multiple through holes serving as the main outlet 172B, and may also refer to the cross-sectional area of a single through hole. Furthermore, the main outlet 172B may also be configured as an annular opening or a single through hole. Similarly, in the condition where the bypass inlet 174A is configured as multiple through holes dispersed and arranged along the circumference, the cross-sectional area of the bypass inlet 174A refers to the total combined cross-sectional area of all the multiple through holes serving as the bypass inlet 174A, and may also refer to the cross-sectional area of a single through hole. Furthermore, the bypass inlet 174A may also be configured as an annular opening or a single through hole. As such, the liquid 102 generates resistance when flowing through the main outlet 172B with small cross-sectional area to the flow path 140, thereby enabling to improve the generated damping force when the buffer device 100 is further connected to the damping force generation device 200. However, the present invention does not limit the shape, quantity, and dimensions of the inlet and outlet of the valve body 170, which may be adjusted according to the needs.

Additionally, in the present embodiment, as shown in FIG. 1 to FIG. 3, the valve body 170 has a cover sealing part 176 that is closer to the cover body 130 than the main outlet 172B (i.e., closer to the upper side in the drawings) and is located between the cover body 130 and the intermediate cylinder 120, and a part of the side surface of the cover body 130 presses the intermediate cylinder 120 and the cover sealing part 176. As an example, the opening 114 of the internal cylinder 110 is more inwardly recessed than the opening 122 of the intermediate cylinder 120 (i.e., closer to the lower side in the drawings), and the cover body 130 covers the outside of the opening 122 of the intermediate cylinder 120 and extends into the intermediate cylinder 120. The end of the cover body 130 extending into the intermediate cylinder 120 is provided with the valve body 170, and the valve body 170 further extends into the internal cylinder 110. The end of the valve body 170 corresponding to the cover body 130 (for example, the upper end in the drawings) is formed with an annular cover sealing part 176. The cover sealing part 176 surrounds the end of the cover body 130 extending into the intermediate cylinder 120, and the cover body 130 closely contacts the intermediate cylinder 120 and the cover sealing part 176 by pressing the intermediate cylinder 120 and the cover sealing part 176 with a part of the side surface. Thus, the liquid 102 flowing to the flow path 140 through the main outlet 172B of the valve body 170 is blocked by the cover sealing part 176 and does not flow toward the cover body 130, thereby enabling prevention of the liquid 102 from overflowing to the outside of the cover body 130. Moreover, the valve body 170 may be positioned by being set between the cover body 130 and the intermediate cylinder 120 through the cover sealing part 176, so that the liquid 102 flowing through the valve body 170 may maintain liquid flow, and the generated damping force may be maintained when the buffer device 100 is further connected to the damping force generation device 200. However, the present invention does not limit the specific structure, installation position, and whether or not to install the cover sealing part 176, which may be adjusted according to the needs.

Similarly, in the present embodiment, as shown in FIG. 2 to FIG. 4, the outer periphery of the valve body 170 is provided with a seal 180, and the seal 180 is positioned between the bypass inlet 174A and the main outlet 172B (which serves as the bypass outlet 174B). More specifically, at least one end of the valve body 170 (for example, the end on the lower side in the drawings) extends into the internal cylinder 110, and the end of the valve body 170 extending into the internal cylinder 110 is provided with a first side part 170S1 having a small radial dimension to be set apart from the internal cylinder 110 to provide the bypass inlet 174A, and a second side part 170S2 having a large radial dimension to contact the inner side surface of the internal cylinder 110. In this way, the valve body 170 may both be provided with the bypass inlet 174A through which the liquid 102 easily flows in, and may contact the inner side surface of the internal cylinder 110 for fixation. At this time, a groove for accommodating the seal 180 is further formed on the outer periphery of the second side part 170S2 of the valve body 170, and the seal 180 is, for example, an annular sealing strip (for example, an O-ring) and may surround the outer periphery of the valve body 170 and be accommodated in the groove. Furthermore, the seal 180 accommodated in the groove may abut against the inner side surface of the internal cylinder 110, thereby further sealing the gap that may exist between the outer periphery of the valve body 170 and the internal cylinder 110. In this way, the seal 180 may prevent the liquid 102 from flowing outside the internal cylinder 110 through gaps other than the main entrance 172A and the bypass inlet 174A. However, the present invention does not limit the specific structure, setting position, and whether or not to set the seal 180, which may be adjusted according to the needs.

Furthermore, in the present embodiment, as shown in FIG. 1 to FIG. 3, a rod guide 190 is provided between the cover body 130 and the piston rod 160. A cover body clearance G2 is provided between the cover body 130 and the rod guide 190, and the cover body clearance G2 is connected with the main flow path 172. The rod guide 190 is, for example, a cylindrical component that is set on the outer periphery of the piston rod 160 and extends in the length direction. The rod guide 190 is positioned between the cover body 130 and the piston rod 160 in the width direction, and is positioned between the cover body 130 and the valve body 170 in the length direction. Moreover, at least a part of the cover body 130 located at the outer peripheral side of the piston rod 160 and the rod guide 190 is set apart from the rod guide 190 to have the cover body clearance G2, and an opening on at least one end (for example, the lower end in the drawing) of the cover body clearance G2 corresponds to one side of the main flow path 172 of the valve body 170 and is connected with the main flow path 172. For example, a part of the main flow path 172 is formed by the space between the inner side surface of the valve body 170 and the outer peripheral surface of the piston rod 160, one end side of the part forms the main entrance 172A, and the other side is connected with the cover body clearance G2. Thus, the piston rod 160 may elongate and contract in the length direction through the guide of the rod guide 190. Moreover, in the process where the liquid 102 flows from the first chamber 112A through the main flow path 172 of the valve body 170 to the flow path 140, the liquid 102 may also flow through the main flow path 172 to the cover body clearance G2, and lubricate the rod guide 190 and the piston rod 160 through the liquid 102. That is, the flow path for providing the liquid 102 to the rod guide 190 and the piston rod 160 is constituted by the cover body clearance G2 and a part of the main flow path 172, thereby enabling further simplification of the structure and providing lubrication effect, and improving the ride comfort performance when the buffer device 100 is applied to a vehicle (not shown). However, the present invention does not limit the specific structure, setting method, and whether to set the cover body clearance G2, which may be adjusted according to the needs.

In summary, in the buffer device of the present invention, through elongation and contraction of the piston rod in the length direction to drive the piston to move reciprocally in the internal cylinder, the liquid may flow in the internal cylinder and the flow path. The valve body connected with the cover body is set between the cover body and the internal cylinder, the first chamber of the internal cylinder and the flow path are connected with each other through the main flow path of the valve body to allow liquid flow, and the length of the main flow path in the radial direction is shorter than the distance between the internal cylinder and the piston rod in the radial direction. In the condition that the piston rod contracts to move the piston toward the second chamber of the internal cylinder, the liquid flows from the second chamber toward the first chamber through the movement of the piston, and then flows toward the flow path more efficiently through the main flow path of the valve body with short length. Thus, the liquid may generate additional damping force reliably at the corresponding part when the piston moves at high velocity, and may generate damping force stably when the buffer device is further connected with the damping force generation device. Preferably, the valve body also has the bypass flow path, the bypass inlet opens toward the side surface of the internal cylinder, and the main outlet serves as the bypass outlet, thereby enabling further simplification of the structure. Accordingly, the buffer device of the present invention may generate more damping force in the high velocity region of the piston velocity to improve damping performance with no response delay, and may improve the ride comfort and handling stability of the vehicle through the improvement of the damping force.

Finally, it should be noted that the above embodiments are only used to illustrate the technical solutions of the present invention, rather than to limit them; although the present invention has been described in detail with reference to the aforementioned embodiments, those of ordinary skill in the art should understand that they may still modify the technical solutions described in the aforementioned embodiments, or make equivalent substitutions for some or all of the technical features thereof; and these modifications or substitutions do not cause the essence of the corresponding technical solutions to depart from the scope of the technical solutions of the embodiments of the present invention.

What is claimed is:

1. A buffer device, comprising:
an internal cylinder, having an internal space, wherein a liquid is sealed in the internal space;
an intermediate cylinder, set on an outer side of the internal cylinder;
a cover body, covering openings located at one end of the internal cylinder and the intermediate cylinder;
a flow path, formed by a space between the internal cylinder and the intermediate cylinder;
a piston, movably mounted in the internal cylinder, and dividing the internal space of the internal cylinder into a first chamber and a second chamber; and
a piston rod, having a first end connected with the piston and a second end extending outward through the first chamber and the cover body, wherein
a valve body connected to the cover body is provided between the cover body and the internal cylinder,
the valve body has a main flow path that communicates with the first chamber and the flow path and allows the liquid to flow therethrough, and
a length of the main flow path in a radial direction is shorter than a distance between the internal cylinder and the piston rod in the radial direction.

2. The buffer device according to claim 1, wherein,
the piston rod has a stopper that sets a stretching distance of the piston rod,
the main flow path has a main entrance opening toward the first chamber and a main outlet opening toward the flow path,
the valve body further has a bypass flow path that communicates with the first chamber and the flow path to allow the liquid to flow through,
the bypass flow path has a bypass inlet opens toward the first chamber and a bypass outlet opens toward the flow path, and
the bypass inlet opens toward a side surface of the internal cylinder.

3. The buffer device according to claim 2, wherein,
the main outlet serves as the bypass outlet, and
the bypass inlet is connected to the main outlet that serves as the bypass outlet.

4. The buffer device according to claim 2, wherein,
the valve body has a cover sealing part that is closer to the cover body than the main outlet and is located between the cover body and the intermediate cylinder, and
a part of a side surface of the cover body presses the intermediate cylinder and the cover sealing part.

5. The buffer device according to claim 3, wherein,
the valve body has a cover sealing part that is closer to the cover body than the main outlet and is located between the cover body and the intermediate cylinder, and
a part of a side surface of the cover body presses the intermediate cylinder and the cover sealing part.

6. The buffer device according to claim 2, wherein,
a cross-sectional area of the main outlet is smaller than a cross-sectional area of the bypass inlet.

7. The buffer device according to claim 3, wherein,
a cross-sectional area of the main outlet is smaller than a cross-sectional area of the bypass inlet.

8. The buffer device according to claim 2, wherein,
the valve body is provided with a seal on an outer periphery of the valve body, and the seal is located between the bypass inlet and the main outlet.

9. The buffer device according to claim 3, wherein,
the valve body is provided with a seal on an outer periphery of the valve body, and the seal is located between the bypass inlet and the main outlet.

10. The buffer device according to claim 1, wherein,
a rod guide is provided between the cover body and the piston rod,
a cover body clearance is between the cover body and the rod guide, and
the cover body clearance is connected with the main flow path.

11. The buffer device according to claim 2, wherein,
a rod guide is provided between the cover body and the piston rod,
a cover body clearance is between the cover body and the rod guide, and
the cover body clearance is connected with the main flow path.

12. The buffer device according to claim 3, wherein,
a rod guide is provided between the cover body and the piston rod,
a cover body clearance is between the cover body and the rod guide, and
the cover body clearance is connected with the main flow path.
